(19) United States
(12) Patent Application Publication
(10) Pub. No.: US 2026/0093250 A1
(43) Pub. Date: Apr. 2, 2026

(54) SYSTEMS AND METHODS FOR GENERATING AND MONITORING A DIGITAL TWIN FOR IDENTIFYING OPERATIONAL VULNERABILITIES IN TECHNICAL COMPONENTS

(71) Applicant: BANK OF AMERICA CORPORATION, Charlotte, NC (US)

(72) Inventor: Frederick Borcherdt, III, Newark, DE (US)

(73) Assignee: BANK OF AMERICA CORPORATION, Charlotte, NC (US)

(21) Appl. No.: 18/904,803

(22) Filed: Oct. 2, 2024

(51) Int. Cl. G05B 23/02

(52) U.S. Cl. CPC G05B 23/0264; G05B 23/0216; G05B 23/027

(57) ABSTRACT

Systems, computer program products, and methods are described herein for generating and monitoring a digital twin for identifying operational vulnerabilities in technical components. The present disclosure is configured to identify at least one technical component facility, wherein the technical component facility comprises a plurality of technical components; apply a data collection mechanism to the plurality of technical components; collect, by the data collection mechanism, metadata associated with the plurality of technical components; and generate, by a digital twin rendering component, a digital twin of the technical component facility, wherein the digital twin rendering component comprises a digital twin of the plurality of technical components in real time.

### TECHNOLOGICAL FIELD

Example embodiments of the present disclosure relate to systems and methods for generating and monitoring a digital twin for identifying operational vulnerabilities in technical components.

### BACKGROUND

In today's current technology environment, so many components perform so many tasks to keep data centers, servers, and/or the like, up and running, and running smoothly without interruption, especially when so many of these facilities comprise so many technical components (e.g., servers, connections, cooling units, and/or the like). Thus, it is extremely difficult for operators of these technical components, data centers, servers, and/or the like, to be aware of each technical malfunction that currently occurs or could occur, and further, to prevent future malfunctions. Thus, a system that can accurately, efficiently, and dynamically generate and monitor a digital twin for identifying operation vulnerabilities in technical components is needed to mitigate current malfunctions, prevent future malfunctions, and plan technical component layouts in these data centers and other facilities.

Applicant has identified a number of deficiencies and problems associated with identifying current and potential operational vulnerabilities in technical component facilities (e.g., data centers, and/or the like). Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for generating and monitoring a digital twin for identifying operational vulnerabilities in technical components.

In one aspect, a system for generating and monitoring a digital twin for identifying operational vulnerabilities in technical components. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one technical component facility, wherein the technical component facility comprises a plurality of technical components; apply a data collection mechanism to the plurality of technical components; collect, by the data collection mechanism, metadata associated with the plurality of technical components; and generate, by a digital twin rendering component, a digital twin of the technical component facility, wherein the digital twin rendering component comprises a digital twin of the plurality of technical components in real time.

In some embodiments, the data collection mechanism crawls a plurality of connections between the plurality of technical components, or the data collection mechanism parses a data collection database comprising the plurality of connections between the plurality of technical components.

In some embodiments, the metadata comprises at least one a technical component location, a technical component downstream list of at least one secondary technical component, a current heat, or at least one connection operatively coupled to the plurality of technical components.

In some embodiments, executing the computer-readable code is further configured to cause the at least one processing device to: monitor current operating metrics of the plurality of technical components; collect a plurality of historical operating metrics for the plurality of technical components; and compare the current operating metrics and the plurality of historical operating metrics. In some embodiments, executing the computer-readable code is further configured to cause the at least one processing device to: determine, based on the comparison of the current operating metrics and the plurality of historical operating metrics, the current operating metrics indicate a current technical malfunction or a predicted technical malfunction of at least one technical component in the at least one technical component facility; generate an alert interface component comprising data associated with the current technical malfunction or the predicted technical malfunction; transmit the alert interface component to a user device associated with the at least one technical component facility; and cause a configuration of a graphical user interface of the user device upon transmission of the alert interface component to the user device.

In some embodiments, wherein executing the computer-readable code is further configured to cause the at least one processing device to: collect current operating metrics of the plurality of technical components; generate a report interface component comprising the current operating metrics for the plurality of technical components; transmit the report interface component to a user device associated with the at least one technical component facility; and cause a configuration of a graphical user interface of the user device upon transmission of the report interface component to the user device.

In some embodiments, the digital twin is a three-dimensional (3D) rendering of the at least one technical component facility.

In some embodiments, executing the computer-readable code is further configured to cause the at least one processing device to: generate, by the digital twin rendering component, a plurality of digital twin renderings of the at least one technical component facility, wherein each digital twin rendering of the plurality of digital twin renderings comprises a plurality of distinct placements of the plurality of technical components; generate a digital twin rendering options interface component comprising the plurality of digital twin renderings; transmit the digital twin rendering options interface component to a user device associated with the at least one technical component facility; and cause a configuration of a graphical user interface of the user device upon transmission of the digital twin rendering options interface component.

In some embodiments, the digital twin comprises a real-time monitoring of the plurality of technical components and a real time copy of the metric data of the plurality of technical components.

In some embodiments, the technical component facility comprises at least one of a data center or a data processing facility.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating and monitoring a digital twin for identifying operational vulnerabilities in technical components, in accordance with an embodiment of the disclosure;

FIG. 2 illustrates a process flow for generating and monitoring a digital twin for identifying operational vulnerabilities in technical components, in accordance with an embodiment of the disclosure;

FIG. 3 illustrates a process flow for generating an alert interface component and configuring a user device's graphical user interface with the alert interface component, in accordance with an embodiment of the disclosure;

FIG. 4 illustrates a process flow for generating a report interface component and configuring a user device's graphical user interface with the report interface component, in accordance with an embodiment of the disclosure; and

FIG. 5 illustrates a process flow for generating a digital twin rendering options interface component and configuring a user device's graphical user interface with the digital twin rendering options interface component, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “technical component” may generally refer to devices, servers, central processing units (CPUs), computers, wired devices in a building, lights, cooling units (such as fans, air conditioners), heating units (e.g., heaters, and/or the like), security panels (e.g., for receiving and authenticating user security cards), and the like. Some example implementations herein contemplate property held by a user, including property that is stored and/or maintained by a third-party entity. In some example implementations, a technical components stored, used, connected, and/or the like, in a technical component facility (e.g., a data center, a central processing facility, a data processing facility, a building comprising systems capable of processing data, capable of being connected to a network, and/or the like).

In today's current technology environment, so many components perform so many tasks to keep data centers, servers, and/or the like, up and running, and running smoothly without interruption, especially when so many of these facilities comprise so many technical components (e.g., servers, connections, cooling units, and/or the like). Thus, it is extremely difficult for operators of these technical components, data centers, servers, and/or the like, to be aware of each technical malfunction that currently occurs or could occur, and further, to prevent future malfunctions. Thus, a system that can accurately, efficiently, and dynamically generate and monitor a digital twin for identifying operation vulnerabilities in technical components is needed to mitigate current malfunctions, prevent future malfunctions, and plan technical component layouts in these data centers and other facilities.

Accordingly, the present disclosure solves the above identified technical problems by at least identifying at least one technical component facility, wherein the technical component facility comprises a plurality of technical components; applying a data collection mechanism to the plurality of technical components; collecting, by the data collection mechanism, metadata associated with the plurality of technical components; and generating, by a digital twin rendering component, a digital twin of the technical component facility, wherein the digital twin rendering component comprises a digital twin of the plurality of technical components in real time.

In other words, the disclosure provides a system for generating a digital twin of a physical environment, such as a data center and/or another such building comprising different technical components such as servers, computing devices, and/or the like. The system may generate the digital twin by first using a crawler method to crawl through the connections within the data center or building, identify the technical components in the building, their current heat and capacity, their connections, their locations, and/or the like. In some embodiments, the system may additionally and/or alternatively access a database comprising all the technical components in use at the data center which may comprise details on the ports currently in use by the components, connections, normal operating metrics, and/or the like for the components. Based on gathering all this data, the system may accurately and efficiently build a digital twin of the data center or building and use the digital twin (or IoT sensors used in conjunction with the digital twin) to monitor each component's current operating metrics, optimize performance of the data center and individual components, and predict future maintenance/send alerts for future maintenance based on current and historical trends.

What is more, the present disclosure provides a technical solution to a technical problem. As described herein, the technical problem includes identifying current and potential operational vulnerabilities in technical component facilities (e.g., data centers, and/or the like). The technical solution presented herein allows for the accurate, efficient, and dynamic generation and monitoring of a digital twin for identifying operation vulnerabilities in technical components is needed to mitigate current malfunctions, prevent future malfunctions, and plan technical component layouts in these data centers and other facilities. In particular, the disclosed provided is an improvement over existing solutions to the identification of current and/or future operational vulnerabilities in technical components and determining optimal layouts of technical components in their associated facilities, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

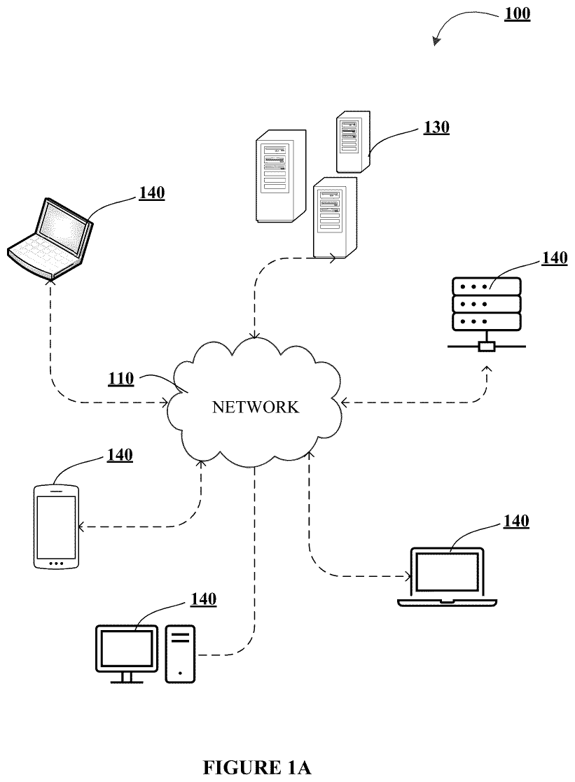

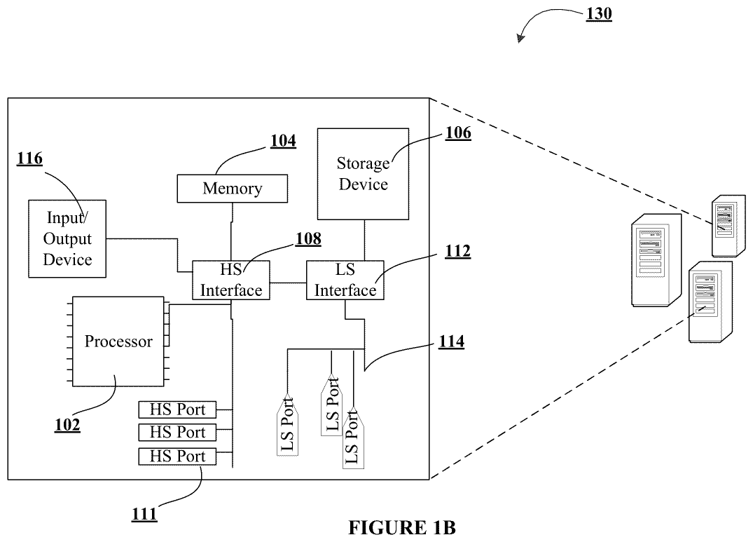

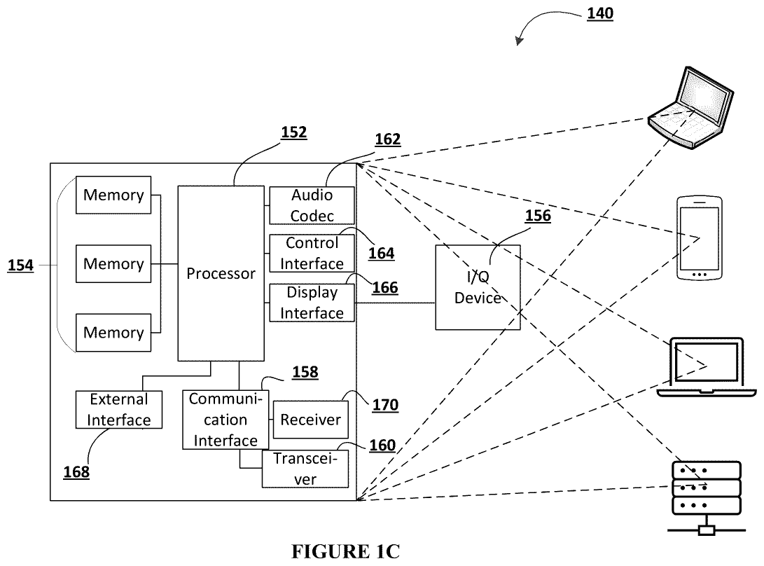

FIGS. 1A-1C illustrate technical components of an exemplary distributed computing environment for generating and monitoring a digital twin for identifying operational vulnerabilities in technical components 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

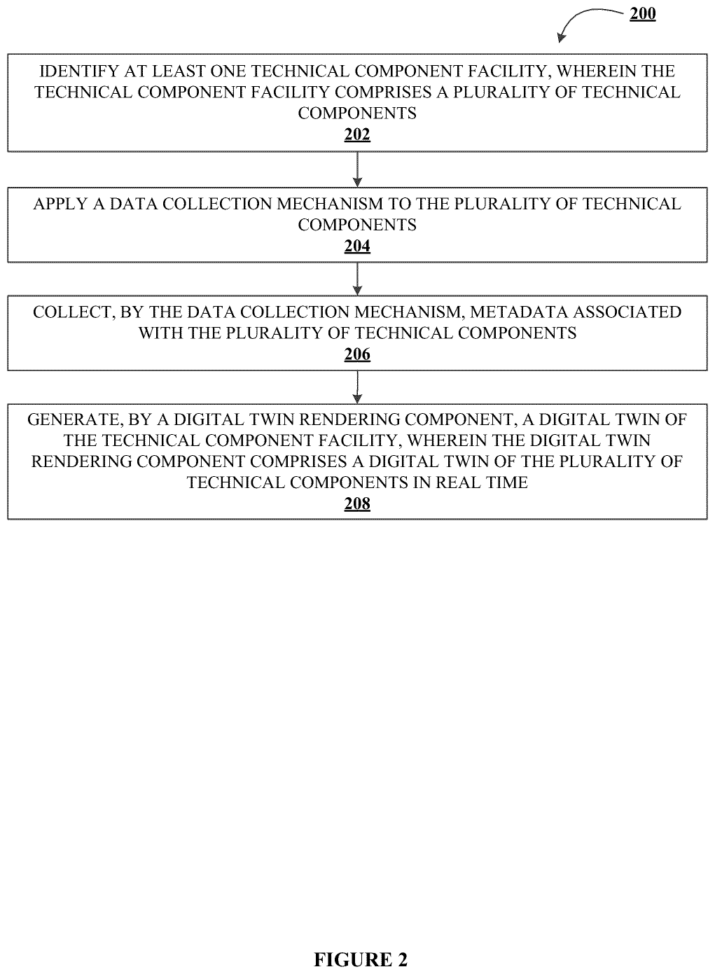

FIG. 2 illustrates a process flow 200 for generating and monitoring a digital twin for identifying operational vulnerabilities in technical components, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying at least one technical component facility, wherein the technical component facility comprises a plurality of technical components. In some embodiments, the system may identify at least one technical facility by receiving an identifier of the technical component facility from a user device associated with the technical component facility (e.g., an owner, operator, manager, and/or the like, who may wish for the system to analyze the identified technical facility and generate a digital twin), which may have been input at a user device and transmitted from the user device to the system described herein via a network (e.g., network 110 of FIG. 1A). In some embodiments, the system may identify the technical component facility based on determining that the technical component facility is next on the system's analysis list, which may have comprised other technical component facilities that are owned, operated, and/or managed by the same entity (e.g., an entity that submitted a request to the system to generate a digital twin of its technical component facilities). In some embodiments, the technical component facility(ies) may be identified by the system after crawling through an entities network and identifying each of its technical component facilities that share or transmit data over the same network or a plurality of the same networks.

As used herein, the phrase “technical component facility” may refer to a building comprising a plurality of devices and/or computing components. Such a building may comprise and/or be a data center; a data processing facility; an office building comprising servers, computers, and/or the like; and/or the like. In some embodiments, the plurality of technical components may comprise, but are not limited to, as but not limited to servers, central processing units (CPUs), cooling units, computers, monitors, telephones, lights, light figures, and/or the like.

As shown in block 204, the process flow 200 may include the step of applying a data collection mechanism to the plurality of technical components. For instance, the system may apply a data collection mechanism to the technical component facility and/or its plurality of technical components, such that the data collection mechanism can collect the metadata from each technical component in the technical component facility. In some embodiments, the data collection mechanism crawls a plurality of connections between the plurality of technical components, or the data collection mechanism parses a data collection database comprising the plurality of connections between the plurality of technical components.

For instance, and in some embodiments, the data collection mechanism may be a crawler mechanism that crawls through each technical component in the technical component facility by crawling through each wired (and in some embodiments, wireless) connection in the technical component facility. In some embodiments, the crawler mechanism may crawl through each connection to identify the location of each technical component (e.g., location within the technical component facility), each other technical component that is connected to the crawled technical component, the crawled technical component's product name/identifier/serial number/model version, and/or the like.

For instance, and in some embodiments, the data collection mechanism may comprise a database crawler, which may crawl through, parse, and extract the metadata associated with each technical component, from a data collection database comprising the current metadata and connections which was generated based on the technical component facility(ies). In such an embodiments, the database crawler may parse and extract the metadata of each technical component in the technical component facility, and such metadata may comprise the location of each technical component (e.g., location within the technical component facility), each other technical component that is connected to the crawled technical component, the crawled technical component's product name/identifier/serial number/model version, and/or the like.

As shown in block 206, the process flow 200 may include the step of collecting, by the data collection mechanism, metadata associated with the plurality of technical components. For instance, the system may collect metadata—using the data collection mechanism—whereby the metadata may be used by the system to accurately generate a digital twin of the technical components in the technical component facility. In some embodiments, the metadata comprises at least one a technical component location, a technical component downstream list of at least one secondary technical component, a current heat, or at least one connection operatively coupled to the plurality of technical components. Thus, such metadata may comprise the connections between each technical component within the technical component facility, which may allow for the system to accurately generate a rendering showing all the connected devices within the technical component facility and, therefore, all the downstream an upstream devices for each device (which could be useful in an instance where one or more devices malfunction or stop working). In some embodiments, the metadata collected may comprise at least one of the dimensions of each technical component, the specifications needed for each technical component to perform properly (e.g., required room heat or operating heat, and/or the like), the model version of each technical component, the network accessed by each technical component, the location of each technical component, the security protocols necessary for a user to access each technical component, the device name for each technical component, a user identifier that can perform maintenance on each technical component, and/or the like.

As shown in block 208, the process flow 200 may include the step of generating, by a digital twin rendering component, a digital twin of the technical component facility, wherein the digital twin rendering component comprises a digital twin of the plurality of technical components in real time. For example, the system may comprise a digital twin rendering component which comprises the capabilities and is configured to generate a digital twin or digital rendering of the technical component facility using the metadata collected in block 206. In some embodiments, the digital twin rendering component may comprise a building modeling technology (e.g., such as but not limited to a Building Information Modeling (BIM) technology, computer aided design and drafting (CADD) design tool, and/or the like). In some embodiments, the digital twin rendering component may comprise an artificial intelligence (AI) engine which is configured to generate the digital twin of the technical component facility by applying the AI engine to the metadata of the technical components in the technical component facility, and the AI engine may output at least one digital twin or digital rendering of the technical component facility.

In such embodiments, and as described herein, the digital twin may refer to a three-dimensional (3D) rendering of the at least one technical component facility. In some embodiments, the digital rendering may also comprise a two-dimensional (2D) rendering of the at least one technical component facility, whereby the 2D rendering may comprise the multi-dimensional view of the technical component facility and its associated metadata.

In some embodiments, the digital twin may comprise a real-time monitoring of the plurality of technical components and a real time copy of the metric data of the plurality of technical components. Thus, and based on the metadata collected for the plurality of technical components (i.e., the current metadata which may further comprise the current performance data, response time data, heat data, and/or the like, of the technical components), the system may continually update the digital twin and its 3D technical components that are rendered in the digital twin with the current metadata for each technical component. In this manner, the digital rendering may comprise an exact and up-to-date replica of the plurality of technical components in the real world, in its 3D environment.

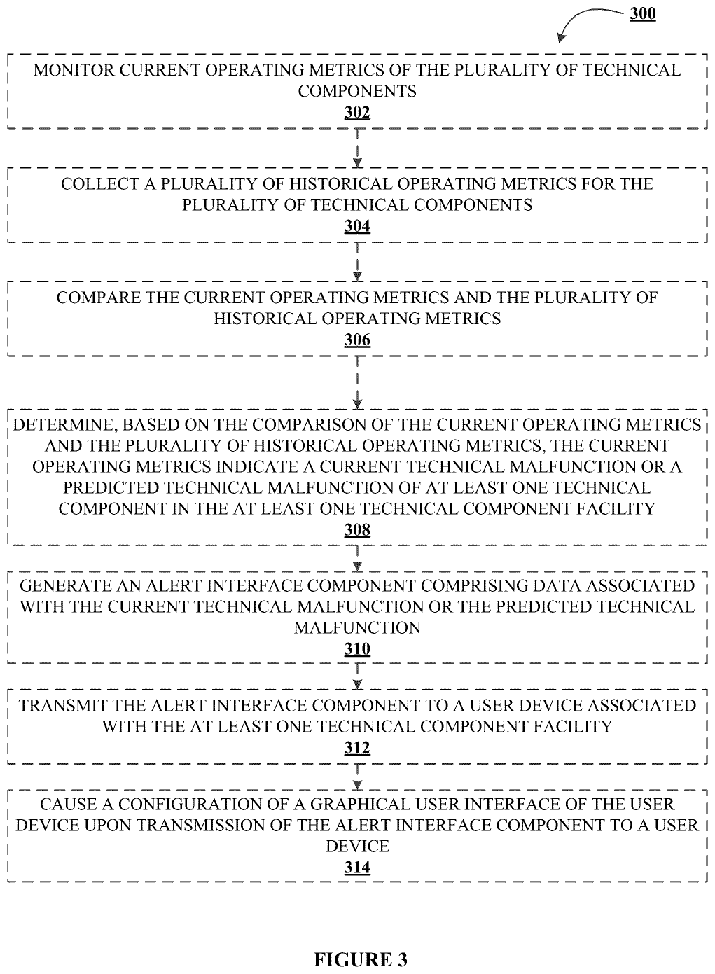

FIG. 3 illustrates a process flow 300 for generating an alert interface component and configuring a user device's graphical user interface with the alert interface component, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of monitoring current operating metrics of the plurality of technical components. Thus, and in some embodiments, the system may monitor the current operating metrics (e.g., the performance of each of the technical components in the technical component facility which may further comprise the response time of the technical components, the ambient heat of the technical components, the current inputs and output data of the technical components, technical component availability, error rates of the technical components, and/or the like). In some embodiments, such current operating metrics may be monitored and collected by the same crawler mechanism and/or database crawler as that mentioned above with respect to FIG. 2. In some embodiments, the monitoring of current operating metrics may be collected by an Internet of Things (IoT) device and/or sensors which are coupled with or attached to the technical components.

In some embodiments, and as shown in block 304, the process flow 300 may include the step of collecting a plurality of historical operating metrics for the plurality of technical components. For instance, the system may collect a plurality of historical operating metrics that were generated and collected from each of the same technical components as the current operating metrics. Thus, and in some such embodiments, the system may identify each technical component that the current operating metrics were monitored and collected from, and then may identify historical operating metrics associated with each of the same technical components identified that the system must collect the historical operating metrics for. In some embodiments, the system may access an operating metrics database that comprises all the historical and past operating metrics for each of the technical components in the technical component facility, and using the same identifiers of the technical component the current operating metrics were collected from, the system may search and extract the historical operating metrics for the same technical components in the operating metrics database. Thus, and in some such embodiments, the system may limit its analysis and processing to the smallest amount of data possible (e.g., only the data associated with the identified technical components) while providing a wholistic view of the performances of each technical component and any possible malfunctions to those technical components.

Additionally, and/or alternatively, the system may only collect the same types of historical operating metrics as the types of current operating metrics already collected in block 302. Thus, and in this manner, when the system is comparing the historical operating metrics and current operating metrics for each of the technical components, the types of data (e.g., ambient heat data of the current operating metrics and ambient heat data of the historical operating metrics) will be of the same type for proper comparison. Thus, and in some such embodiments, upon collecting the same types of historical operating metrics, the system may limit its data for analysis and processing to only the data necessary to complete the comparison with the current operating metrics already collected.

In some embodiments, the same database crawler as the database crawler described above with respect to FIG. 2 may be used to identify and collect the historical operating metrics in the operating metrics database. In some embodiments, the IoT sensors and/or devices may be used to identify and collect the historical operating metrics.

In some embodiments, and as shown in block 306, the process flow 300 may include the step of comparing the current operating metrics and the plurality of historical operating metrics. For example, and in some such embodiments, the system may compare the current operating metrics with the historical operating metrics by comparing the current operating metrics collected to all the historical operating metrics that match the same type. In some embodiments, the comparison may comprise a one-to-one comparison (e.g., where only one historical operating metric has been previously collected and compared to the only one current operating metric of the same type), a plurality-to-one (e.g., where a plurality of historical operating metrics has been previously collected and compared to the only one current operating metric of the same type, such as where only one value or performance metric is actually collected or where a plurality of current metrics are collected and averaged), or a plurality-to-plurality (e.g., where a plurality of historical operating metrics has been previously collected and compared to a plurality of current operating metrics of the same type, such as a plurality of ambient heat values over a current period).

As used herein, the terms “comparing” and “comparison” refers to an analysis between at least two pieces of data (e.g., here at least one historical operating metric and at least one current operating metric) to determine the similarities and differences, and to what degree the similarities and differences are. In some embodiments, the comparison of the historical operating metrics and the current operating metrics may comprise comparison of values between the historical operating metrics and the current operating metrics (e.g., historical ambient heat values compared with current ambient heat values, historic response times and current response times, historical error counts compared with current error counts, and/or the like), and based on this comparison of values, the system may determine a difference value or score between the historical value(s) and the current value(s). In some embodiments, the difference value or score may be compared against a difference threshold, whereby the difference threshold may be pre-determined based past or historical instances of malfunction, based on a user input (e.g., a manager, operator, owner, or specialist user input for the technical component), and the difference threshold may indicate a potential malfunction for the technical component is predicted to happen in the future or already occurring. For instance, and in some such embodiments, in an instance where the difference value meets or exceeds the difference threshold (e.g., where the difference value indicates a spike/increase in ambient heat from historical ambient heat to the current ambient heat by 20 degrees, and the difference threshold is 4 degrees), then the system may determine a malfunction in the technical component is likely to occur soon or is already occurring (e.g., the technical component may overheat). Additionally, and in an instance where the difference does not meet or exceed the difference threshold, then the system may determine no malfunction is occurring or is likely to occur based on the current operating metrics. Similar comparisons may be done on response time, error counts, and the other such metadata, and operating metrics collected, identified, and described herein.

In some embodiments, and as shown in block 308, the process flow 300 may include the step of determining, based on the comparison of the current operating metrics and the plurality of historical operating metrics, the current operating metrics indicate a current technical malfunction or a predicted technical malfunction of at least one technical component in the at least one technical component facility. For instance, and in some such embodiments, the system may compare the historical operating metrics and the current operating metrics for each technical component, and based on this comparison, identify which technical components may have a technical malfunction currently and/or will have a technical malfunction in the future. Such a technical malfunction refers to a failure or interruption to the technical component in working or operating in its normal manner or for its intended function. Thus, and by way of non-limiting example, if the technical component were to overheat (like the example described hereinabove), and the technical component were to stop performing its intended function due to its overheating (and in some instances shutting down, slowing down, or restarting), then the system may determine the technical malfunction is predicted as the technical component may not have started slowing down, shutting down, or restarting. Likewise, and where the technical component has already started slowing down in its response time, then the system may determine the technical component is undergoing a current technical malfunction.

In some embodiments, and based on the comparison of the technical components in the technical component facility, only one technical component may be determined to have a current or predicted technical malfunction, or a plurality of technical components may be determined to have current or predicted technical malfunctions at once. Thus, and in some such embodiments, the system may accurately and efficiently analyze and determine the likelihood of technical malfunctions across the entire technical component facility at once (in parallel) and/or in near real time to each other (such that the determination of technical component malfunctions occur at the basically the same time to a user).

In some embodiments, and as shown in block 310, the process flow 300 may include the step of generating an alert interface component comprising data associated with the current technical malfunction or the predicted technical malfunction. For instance, and in some such embodiments, the system may generate an alert interface component which comprises the data regarding the technical components comprising current or predicted technical malfunctions (e.g., the underlying operating metrics that caused the determination of the technical malfunction determination, the location of the technical component associated with the technical component malfunction, the technical component identifier, model number, serial number, and/or the like). Such an alert interface component may comprise the data associated with the technical component(s) associated with the technical malfunction determinations (current and/or predicted) in a computer-readable format, which may then be transmitted to a user device comprising a graphical user interface, and may be used to configure the graphical user interface of the user device to show the data of the technical component(s) associated with the technical malfunction(s). In some such embodiments, the alert interface component may show a pop-up notification on the user device's by configuring the user device's graphical user interface automatically and in near real time to determining the technical malfunction(s).

In some embodiments, and as shown in block 312, the process flow 300 may include the step of transmitting the alert interface component to a user device associated with the at least one technical component facility. For instance, and in some such embodiments, the system may determine which user device(s) to transmit the alert interface component to, whereby the user device(s) selected to receive the alert interface component may be those user devices that are currently located nearest the technical component associated with the technical malfunction (e.g., which may be based on the digital twin and a current global positional system (GPS) tracking of the user devices currently in the technical component facility), may be those user devices associated with owning, operating or managing the technical component associated with the technical malfunction (e.g., information technology (IT) users that have previously fixed the technical component(s) or are tasked with fixing the technical component(s)), may be those user devices associated with a user that comprises the security clearance to access the technical component(s), may be those user devices associated with a user comprising specialized knowledge of the technical component, and/or the like. In some embodiments, and where the GPS tracking of the user devices within the technical component facility is used to determine the closest location of the users to the technical components, the system may overlay a diagram of all the user devices and their current positioning in the digital twin to make such a determination accurately (e.g., such that the determination is made based on a 3D rendering, especially for those technical component facilities comprising multiple floors, instead of a 2D rendering in the normal map rendering).

Additionally, and in some such embodiments, the alert interface component and its computer-readable data may be transmitted as a data packet/package over a network (e.g., the network 110 of FIG. 1A), to the determined or selected user device that is associated with a user to resolve the technical malfunction.

Additionally, and in some embodiments, different alert interface components may be generated and transmitted to different user devices depending on which technical component the alert interface component is associated with. Thus, and in some such embodiments, a plurality of alert interface components may be generated with different data associated with different technical components, and each alert interface component may be transmitted to some of the same, or different user devices, depending on which user devices and their associated users are able to resolve the technical component malfunction(s).

In some embodiments, and as shown in block 314, the process flow 300 may include the step of causing a configuration of a graphical user interface (GUI) of the user device upon transmission of the alert interface component to a user device. For instance, and in some such embodiments, the system may—by transmitting the alert interface component—may automatically trigger the configuration of the GUI of the user device to show the data of the alert interface component. Such a configuration of the GUI may show the location of the technical component(s), the identifier or product name of the technical component, the technical malfunction that was determined (e.g., current and/or predicted, and a brief explanation of the malfunction type, such as overheating, shutting down, error counts, and/or the like), a time of the determined technical malfunction, and/or the like. In some embodiments, the location of the technical component may further comprise an interactive map the user of the user device may interact with on the GUI, which may update continuously as the user moves toward the technical component. Such an embodiment may be based on current GPS tracking of the user device. In some embodiments, the alert interface component may be shown as a pop up notification on the user device, and/or the like.

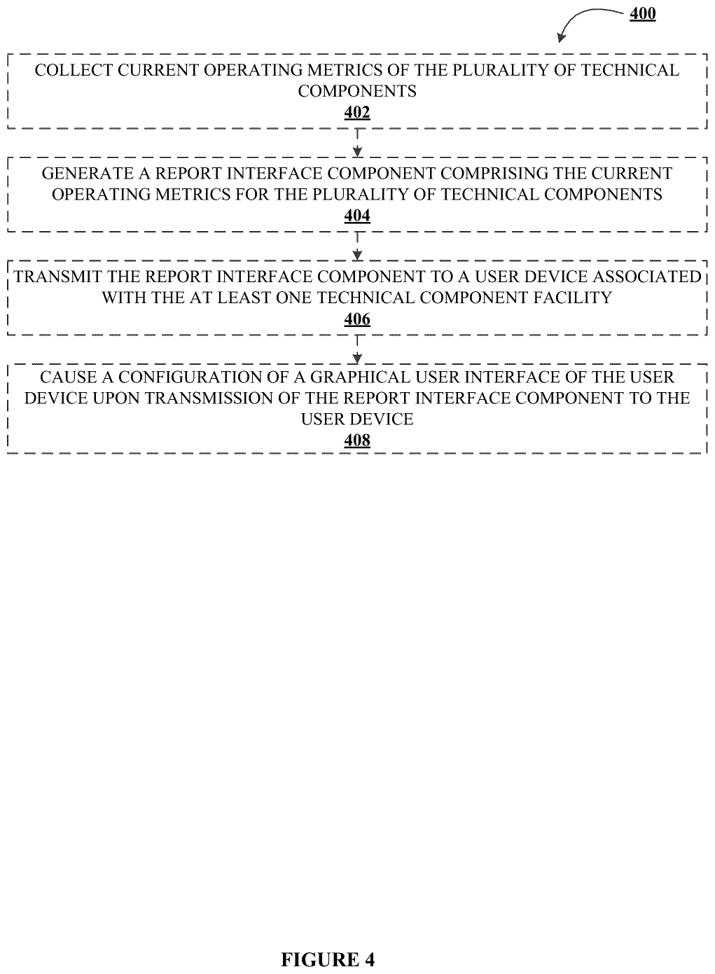

FIG. 4 illustrates a process flow 400 for generating a report interface component and configuring a user device's graphical user interface with the report interface component, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of collecting current operating metrics of the plurality of technical components. For example, and in such an embodiment, the system may collect current operating metrics in the same or similar manner as the collection of the current operating metrics described hereinabove with respect to block 302. Thus, and similar to the description provided above, the system may collect the current operating metrics from the plurality of technical components in the technical component facility using any of the methods or mechanisms described above for collecting the current operating metrics in FIG. 3 (e.g., crawling mechanism, a database mechanism, an IoT sensor or device, and/or the like).

In some embodiments, and as shown in block 404, the process flow 400 may include the step of generating a report interface component comprising the current operating metrics for the plurality of technical components. Thus, and in some such embodiments, the system may generate a report interface component comprising the data of the current operating metrics of the plurality of technical components in a computer-readable format within a transmittable data packet. In other words, the system may generate a report interface component to transmit to a user device (or a plurality of user devices), to configure a GUI of the user device(s) to show the current performance data of each technical component in the technical component facility. In this manner, the report interface component may comprise an overall report or dashboard of all the technical components and their current data as each technical component performs their functions.

In some embodiments, and as shown in block 406, the process flow 400 may include the step of transmitting the report interface component to a user device associated with the at least one technical component facility. For instance, and in some such embodiments, the system may transmit the report interface component to at least one user device associated with the at least one technical component facility (e.g., a user device associated with an owner, operator, or manager of technical component facility; a user device associated with a technical component specialist of at least some of the technical components in the technical component facility; and/or the like). In some embodiments, the same user device(s) determined to receive the alert interface component of FIG. 3 may additionally receive the report interface component for all the technical components in the technical component facility. Thus, and in some embodiments, the same analysis performed above with respect to determining the recipient user device(s) for the alert interface component may occur here for determining the recipient user device(s) of the report interface component. In some embodiments, the same analysis provided above may only occur for determining the recipient of the report interface component (e.g., such as where not technical malfunctions are determined).

In some embodiments, and as shown in block 408, the process flow 400 may include the step of causing a configuration of a graphical user interface of the user device upon transmission of the report interface component to the user device. For instance, and in some embodiments, the system may trigger a configuration of the GUI of the recipient user device upon transmitting the report interface component/upon the user device receiving the report interface component. Thus, and similar to the configuration of the user device(s) with the alert interface component(s), the system may likewise automatically and in real time or near real time cause a configuration of the recipient user device's GUI upon receiving the report interface component.

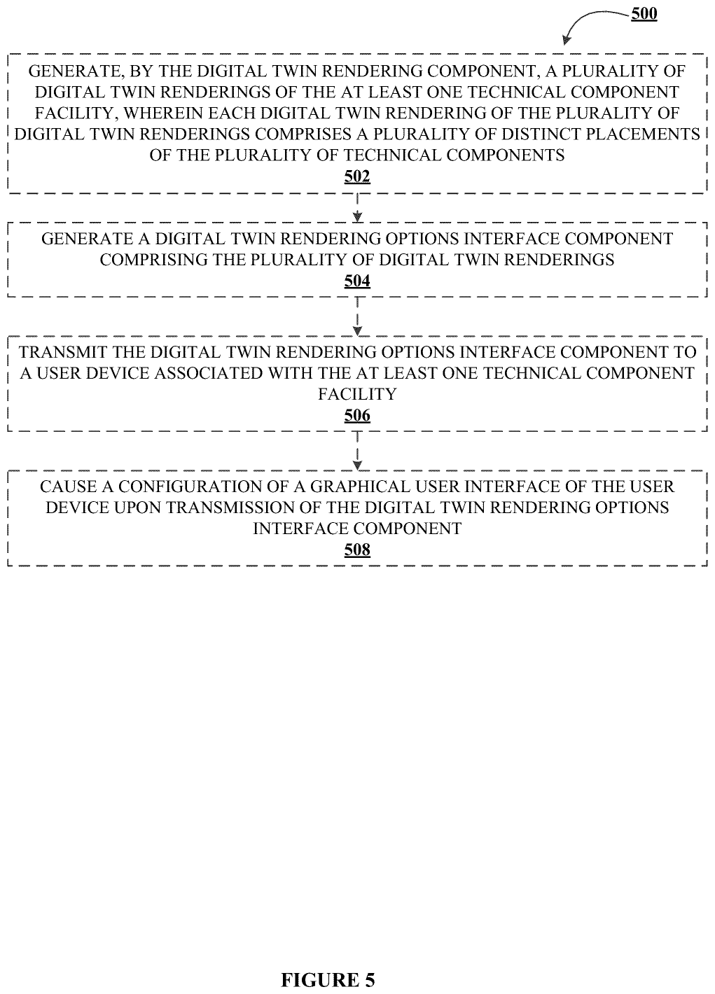

FIG. 5 illustrates a process flow 500 for generating a digital twin rendering options interface component and configuring a user device's graphical user interface with the digital twin rendering options interface component, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of generating, by the digital twin rendering component, a plurality of digital twin renderings of the at least one technical component facility, wherein each digital twin rendering of the plurality of digital twin renderings comprises a plurality of distinct placements of the plurality of technical components. For instance, and in some embodiments, the system may generate—using the same digital twin rendering component described above—a plurality of digital twin renderings, whereby the digital twin renderings comprise a plurality of optional digital renderings each comprising a different layout for the plurality of technical components in the 3D environment. Each, different layout may refer to a layout or organization of the plurality of technical components where at least one technical component may comprise a different location from at least one other layer (e.g., if the technical components A, B, C, D, and are organized next to each other as A, B, C, and D, then a different layout may comprise at least one change to the positioning of any of one A, B, C, or D). Further, and in some embodiments, the different layouts may each comprise at least one different connection between the plurality of technical components (e.g., where A is connected to B and B is connected to C and D, then a different layout may comprise A being connected to B, C, and D, directly). Thus, and as used herein, the distinct placement of the plurality of technical components refers to different layouts, whereby at least one technical component's placement (or connection(s)) is different form the other digital twin renderings.

In some embodiments, the digital twin renderings may each be simulated according to real-world requirements and activities on the technical components, such that each rendering/layout may be tested according to current and projected technical component requirements (e.g., some technical components may need to be placed near a cooling unit to avoid overheating at certain activities, or certain levels of processing). Thus, and in some embodiments, the digital twin renderings may comprise an application of real world simulations for each technical component in the 3D environment, such that the digital rendering can be tested virtually before testing in real life. Further, and in some embodiments, the simulation according to real-world requirements may allow for a simulation of energy performance for the entire technical component facility, and may allow for the system to identify opportunities to improve efficiency, energy, performance, and/or the like, of each technical component on both a granular scale (e.g., individually) or on a broad scale (e.g., multiple technical components and/or the entire technical component facility).

In some embodiments, and as shown in block 504, the process flow 500 may include the step of generating a digital twin rendering options interface component comprising the plurality of digital twin renderings. For instance, and in some embodiments, the system may generate a digital twin rendering options interface component, whereby the digital twin rendering options interface component comprises data of the distinct placements for each digital twin rendering, and in some embodiments, the simulated metric data of each digital twin rendering, such that the user of the user device that receives the digital twin rendering options interface component can test and see the predicted performance of each technical component in their placement positions on a granular scale (technical component by technical component) and/or on a large scale (all the technical components as they interact with each other). Thus, and in such embodiments, the digital twin rendering options interface component may comprise the data of the plurality of digital twin renderings in a computer-readable data packet, and where the computer-readable data packet may be transmitted to a recipient user device and used to configure a GUI of the recipient user device to show the data of the digital twin rendering options interface component (e.g., plurality of digital twin renderings and, in some embodiments, their simulated metric data).

In some embodiments, and as shown in block 506, the process flow 500 may include the step of transmitting the digital twin rendering options interface component to a user device associated with the at least one technical component facility. For instance, and in some embodiments, the system may transmit the digital twin rendering options interface component to at least one user device (or a plurality of user devices), such as but not limited to the user devices associated with an owner, operator, or manager of the technical component facility, an information technology (IT) user's user device associated with the technical component facility, and/or the like. In some embodiments, the determination or selection of a recipient user device(s) may be determined using the same or similar process as that described above with respect to FIGS. 3 and 4 for selecting the recipient user device of the alert interface component and/or the report interface component.

In some embodiments, and as shown in block 508, the process flow 500 may include the step of causing a configuration of a graphical user interface of the user device upon transmission of the digital twin rendering options interface component. Thus, and similar to description provided hereinabove with respect to FIGS. 3 and 4, the system may automatically and in real time or near real time cause the configuration of the recipient user device's GUI with the digital twin rendering options interface component to show the different options for layout of the plurality of technical components (and in some embodiments, each different layout's simulated metric data), such that a user may determine the most optimal layout to configure the real-world technical components in the technical component facility. Thus, the configured GUI of the user device may show each of the plurality of digital twin renderings to the user, such that the user may determine the optimized or best performing layout for the real-world technical components which may proactively prevent future and current malfunctions to the technical components.

### Example Use Cases

Thus, and as described herein, the system allows for an automated method for creating a digital twin of a technical component facility, such as but not limited to data centers, data processing facilities, office buildings, and/or the like. The system described herein may allow for significant advantages in designing, constructing, and operating these technical component facilities in many ways.

For instance, and in some embodiments, the system may create highly detailed 3D models of the technical component facility(ies), which may comprise all the physical components such as racks, cooling systems, electrical systems, structural elements, the connections between each physical component, and/or the like. Further, the system may allow for space optimization by modeling different layout scenarios and identifying the most efficient/optimal configuration.

Additionally, and in some embodiments, the system may allow for integrated workflows, where—on the front end—architects, engineers, and IT professionals of these technical component facilities may use this system to collaborate on a unified 3D model, which may ensure that all the physical components are coordinated, and conflicts are resolved early in the design process. Further, the system may allow for the proactive detection of conflicts or clashes (e.g., identifying and resolving conflicts between different systems such as but not limited to HVAC, electrical, network cabling, and/or the like) before construction begins and/or before reconfiguring a technical component facility's components. Additionally, the system may allow for detailed plans to be generated (e.g., detailed construction documents which may be built directly from the digital twin and/or 3D model, which may further comprise product identifiers, product placements, connections between products, and/or the like) which may thus reduce errors and discrepancies in the construction/reconfiguration phase. In some embodiments, the system may further allow for construction sequencing, which ma be used to plan and visualize construction or reconfiguration sequences, ensuring the build process is efficient and logical.

In some embodiments, the system may further allow for an accurate cost estimation and manage budgets efficiently and accurately. Further, the system may allow for proper resource management of both the technical components and the personnel needed to configure the technical components by tracking and managing resources, ensuring that materials and labor are available when needed, which may in turn reduce delays.

The system may additionally allow for improvements in operations and maintenance of the technical component facility(ies). For instance, the system may comprise real-time monitoring by creating the digital twin of the technical component facility that mirrors the physical environment in real-time, integrating with IoT sensors and monitoring systems. Further, the system may allow for predictive maintenance of the plurality of technical components by using the digital twin to predict maintenance needs and optimize the performance of critical systems such as power and cooling.

The system may further improve energy efficiency and sustainability, such as by simulating performance and sustainability analysis. For instance, the system may simulate performance using the digital twin to simulate the energy performance of the data center, identifying opportunities to improve energy efficiency. Additionally, the system may conduct sustainability analyses to ensure the technical component facility meets environmental standards and certifications.

With respect to scalability and future upgrades, the system may also improve future planning. For instance, the system may use the digital twin to plan for future expansions and upgrades, ensuring that the data center can scale to meeting growing demands. Further, the system may maintain comprehensive documentation of the data center's infrastructure, facilitating easier upgrades and changes.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating and monitoring a digital twin for identifying operational vulnerabilities in technical components, the system comprising:
a memory device with computer-readable program code stored thereon;
at least one processing device operatively coupled to the at least one memory device and the at least one communication device, wherein executing the computer-readable code is configured to cause the at least one processing device to:
identify at least one technical component facility, wherein the technical component facility comprises a plurality of technical components;
apply a data collection mechanism to the plurality of technical components;
collect, by the data collection mechanism, metadata associated with the plurality of technical components; and
generate, by a digital twin rendering component, a digital twin of the technical component facility, wherein the digital twin rendering component comprises a digital twin of the plurality of technical components in real time.

2. The system of claim 1, wherein the data collection mechanism crawls a plurality of connections between the plurality of technical components, or the data collection mechanism parses a data collection database comprising the plurality of connections between the plurality of technical components.

3. The system of claim 1, wherein the metadata comprises at least one a technical component location, a technical component downstream list of at least one secondary technical component, a current heat, or at least one connection operatively coupled to the plurality of technical components.

4. The system of claim 1, wherein executing the computer-readable code is further configured to cause the at least one processing device to:
monitor current operating metrics of the plurality of technical components;
collect a plurality of historical operating metrics for the plurality of technical components; and
compare the current operating metrics and the plurality of historical operating metrics.

5. The system of claim 4, wherein executing the computer-readable code is further configured to cause the at least one processing device to:
determine, based on the comparison of the current operating metrics and the plurality of historical operating metrics, the current operating metrics indicate a current technical malfunction or a predicted technical malfunction of at least one technical component in the at least one technical component facility;
generate an alert interface component comprising data associated with the current technical malfunction or the predicted technical malfunction;
transmit the alert interface component to a user device associated with the at least one technical component facility; and
cause a configuration of a graphical user interface of the user device upon transmission of the alert interface component to the user device.

6. The system of claim 1, wherein executing the computer-readable code is further configured to cause the at least one processing device to:
collect current operating metrics of the plurality of technical components;
generate a report interface component comprising the current operating metrics for the plurality of technical components;
transmit the report interface component to a user device associated with the at least one technical component facility; and
cause a configuration of a graphical user interface of the user device upon transmission of the report interface component to the user device.

7. The system of claim 1, wherein the digital twin is a three-dimensional (3D) rendering of the at least one technical component facility.

8. The system of claim 1, wherein executing the computer-readable code is further configured to cause the at least one processing device to:
generate, by the digital twin rendering component, a plurality of digital twin renderings of the at least one technical component facility, wherein each digital twin rendering of the plurality of digital twin renderings comprises a plurality of distinct placements of the plurality of technical components;
generate a digital twin rendering options interface component comprising the plurality of digital twin renderings;
transmit the digital twin rendering options interface component to a user device associated with the at least one technical component facility; and
cause a configuration of a graphical user interface of the user device upon transmission of the digital twin rendering options interface component.

9. The system of claim 1, wherein the digital twin comprises a real-time monitoring of the plurality of technical components and a real time copy of the metric data of the plurality of technical components.

10. The system of claim 1, wherein the technical component facility comprises at least one of a data center or a data processing facility.

11. A computer program product for generating and monitoring a digital twin for identifying operational vulnerabilities in technical components, the computer program product comprising a non-transitory computer-readable medium comprising code causing an apparatus to:
identify at least one technical component facility, wherein the technical component facility comprises a plurality of technical components;
apply a data collection mechanism to the plurality of technical components;
collect, by the data collection mechanism, metadata associated with the plurality of technical components; and
generate, by a digital twin rendering component, a digital twin of the technical component facility, wherein the digital twin rendering component comprises a digital twin of the plurality of technical components in real time.

12. The computer program product of claim 11, wherein the data collection mechanism crawls a plurality of connections between the plurality of technical components, or the data collection mechanism parses a data collection database comprising the plurality of connections between the plurality of technical components.

13. The computer program product of claim 11, wherein the metadata comprises at least one a technical component location, a technical component downstream list of at least one secondary technical component, a current heat, or at least one connection operatively coupled to the plurality of technical components.

14. The computer program product of claim 11, wherein the computer program product comprising the non-transitory computer-readable medium comprising code causing the apparatus to:
collect current operating metrics of the plurality of technical components;
generate a report interface component comprising the current operating metrics for the plurality of technical components;
transmit the report interface component to a user device associated with the at least one technical component facility; and
cause a configuration of a graphical user interface of the user device upon transmission of the report interface component to the user device.

15. The computer program product of claim 11, wherein the digital twin is a three-dimensional (3D) rendering of the at least one technical component facility.

16. A computer implemented method for generating and monitoring a digital twin for identifying operational vulnerabilities in technical components, the method comprising:
identifying at least one technical component facility, wherein the technical component facility comprises a plurality of technical components;
applying a data collection mechanism to the plurality of technical components;
collecting, by the data collection mechanism, metadata associated with the plurality of technical components; and
generating, by a digital twin rendering component, a digital twin of the technical component facility, wherein the digital twin rendering component comprises a digital twin of the plurality of technical components in real time.

17. The computer implemented method of claim 16, wherein the data collection mechanism crawls a plurality of connections between the plurality of technical components, or the data collection mechanism parses a data collection database comprising the plurality of connections between the plurality of technical components.

18. The computer implemented method of claim 16, wherein the metadata comprises at least one a technical component location, a technical component downstream list of at least one secondary technical component, a current heat, or at least one connection operatively coupled to the plurality of technical components.

19. The computer implemented method of claim 16, further comprising:
collecting current operating metrics of the plurality of technical components;
generating a report interface component comprising the current operating metrics for the plurality of technical components;
transmitting the report interface component to a user device associated with the at least one technical component facility; and
causing a configuration of a graphical user interface of the user device upon transmission of the report interface component to the user device.

20. The computer implemented method of claim 16, wherein the digital twin is a three-dimensional (3D) rendering of the at least one technical component facility.
